(19) United States
(12) Patent Application Publication
(10) Pub. No.: US 2016/0308685 A1
(43) Pub. Date: Oct. 20, 2016

(54) DYNAMIC RESOURCE LIST SUBSCRIPTIONS

(71) Applicant: Avaya Inc., Santa Clara, CA (US)

(72) Inventors: Milos Pujic, Belleville (CA); Geoff Baskwill, Almonte (CA); Ming Hou, Belleville (CA); Joshua Bertoulin, Brentwood, NH (US)

(21) Appl. No.: 14/691,264

(22) Filed: Apr. 20, 2015

(51) Int. Cl. H04L 12/18; H04L 29/08

(52) U.S. Cl. CPC H04L 12/1818; H04L 67/24

(57) ABSTRACT

Telephonic and other endpoints often make presence information of other users available on the endpoint. Systems whereby every user sends a notification to every other user quickly becomes resource intensive. Providing presence information only to users subscribed to the presence of other users helps; but, maintaining such subscriptions is often overlooked. Providing automatic subscriptions based upon a triggering event allows presence information to be provided to associated users. The presence information may be time limited to allow for an appropriate amount of presence information to be provided for a duration most likely determined to be relevant. Upon expiration of the subscription, the utilized resources are released without requiring any human intervention.

### FIELD OF THE DISCLOSURE

The present disclosure is generally directed to presence indicators for subscribers to an electronic communication system.

### BACKGROUND

Users of presence services, such as Avaya Aura™ Presence Services, receive updates based on a “buddy list” setup by the user to receive presence information for a set of other users of the system (“buddies”). A user subscribes to other users for updates and shared knowledge about the users. Once the buddy list is defined, the presence server and endpoints can share information.

Buddy lists tend to be resource intensive as each user notifies each subscriber of their change in availability, even if few or no subscribers are currently interested in the user's current status. Buddy lists also tend to grow over time. A user may be on a project with one group where having presence information is useful for a period of time. However, even if the project ends, few users will unsubscribe the users of the group. As a result, a user's endpoint may receive a substantial volume of presence notifications, even if few are of current interest.

### SUMMARY

It is with respect to the above issues and other problems that the embodiments presented herein were contemplated. In one embodiment, a dynamic presence resource list mechanism is provided that allows a user to remove and add presence subscriptions dynamically for a set amount of time and which is managed automatically by a server. Once the time lapses, the subscribed users are unsubscribed. The presence server may carry the subscribe/unsubscribe deltas and may more readily facilitate a re-subscribe to one of the unsubscribed users. In other embodiments, events may use need-based triggers to cause the subscription of presence information. When the need no longer exists, the presence information may be unsubscribed.

In another embodiment, a user may want presence information for people who are not on their buddy list. The presence server can allow the user to request presence for non-buddy list users. For example, in systems that provide presence for users on an email distribution list, the user can see presence information for some or all of those users (e.g., sender, other recipients, and/or “cc” recipients), even for those users who are not on the buddy list. In a further embodiment, the presence information for non-buddy list users may be limited by time. For example, presence for parties associated with an email may be useful for a limited timeframe, (e.g., follow-up questions, schedule a meeting, correct an error, etc.), however, the steps of adding such users to a buddy list (e.g., formulating a request, sending the request, the recipient seeing the request, the recipient acting on the request, the server updating the buddy list, etc.) may be difficult for the user to justify. As a benefit, users may find it helpful to have and manage contacts on the buddy list (static relationship) as well as to have context-based presence displayed (ad hoc relationship) dynamically.

In one embodiment, the initial subscription request carries the initial resource list in a message body. The initial resource list may be modified, such as by a subscription refresh request comprising a list of additions and deletions.

For each entry in the resource list, a subscribing application can specify appropriate treatment of the request according to the access control policy, which applies to a specific entry: (1) if the policy is CONFIRM, which may trigger a presence watching authorization request—this is more appropriate for longer-term watching, or (2) the CONFIRM policy may be processed in a manner equivalent to that of a BLOCK policy for such ad hoc relationships. Requests that are blocked may omit notification to the receiving and/or providing user, such as when the providing user is subject to a default personal, corporate, or other entity's BLOCK policy.

As a benefit, a user or group of users (e.g., department, position, company, enterprise, etc.) may maintain privacy according to a default policy in order to manage privacy concerns. User's may still issue a request to subscribe to a user's presence via an explicit request, which may then explicitly notify the user of the acceptance/refusal response.

Reducing the number of “transactions” between the endpoint and the presence server related to managing the dynamic list by:

1. Allowing one or more presence data, including specific presence datum for the one or more users providing the presence data, to be added/removed from the list by a single “transaction” between the endpoint and the presence server; and/or

2. Allowing specifying the “privacy handling instructions” per individual basis.

In one embodiment, a system is disclosed, comprising: a presence server; an input interface of the presence server configured to receive a triggering event from a triggering device; wherein the triggering device notifies the presence server, via the input interface, of a triggering event associating the first user with the second user; wherein the presence server, in response to the triggering event, automatically and without human intervention, in response to the triggering event, subscribes the first user to presence data for the second user; and an output interface of the presence server configured to provide presence information of the second user to a first endpoint associated with the first user while the first user is subscribed to the presence data of the second user.

In another embodiment, a method is disclosed, comprising: receiving a triggering event from a triggering device indicating an association between a first user and a second user; in response to the triggering event, automatically and without human intervention, subscribing the first user to presence data for the second user; receiving presence data of the second user from a second endpoint associated with the second user; and determining the first user is presently subscribed to the presence data of the second user, and in response to the determining, outputting the presence data of the second user to a first endpoint associated with the first user.

In another embodiment, a non-transitory computer-readable medium is disclosed that when read by a computer causes the computer to perform: receiving a triggering event from a triggering device indicating an association between a first user and a second user; in response to the triggering event, automatically and without human intervention, subscribing the first user to presence data for the second user; receiving presence data of the second user from a second endpoint associated with the second user; and determining the first user is presently subscribed to the presence data of the second user, and in response to the determining, outputting the presence data of the second user to a first endpoint associated with the first user.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the presence disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The presence disclosure is described in conjunction with the appended figures:

FIG. 1 depicts a system in accordance with embodiments of the presence disclosure;

FIG. 2A depicts a first endpoint in accordance with embodiments of the presence disclosure;

FIG. 2B depicts a second endpoint in accordance with embodiments of the presence disclosure;

FIG. 2C depicts a third endpoint in accordance with embodiments of the presence disclosure;

FIG. 3 depicts a first process in accordance with embodiments of the presence disclosure;

FIG. 4 depicts a second process in accordance with embodiments of the presence disclosure; and

FIG. 5 depicts a third process in accordance with embodiments of the presence disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the presence disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

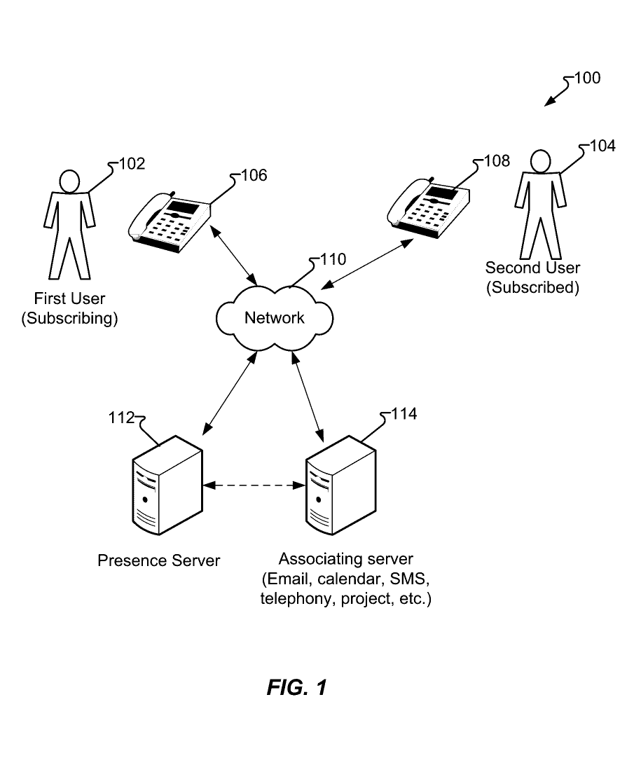

FIG. 1 depicts system 100 in accordance with embodiments of the present disclosure. In one embodiment, system 100 illustrates first endpoint 106 and second endpoint 108 logically connected via network 110. First endpoint 106 is associated with first user 102 and second endpoint 108 is associated with second user 104. The associations between a particular user and a particular endpoint (e.g., first user 102 with first endpoint 106 and second user 104 and second endpoint 108) may be static, such as when an endpoint is a cell phone used solely by a particular user, or dynamic, such as when a user has signed on to a particular endpoint for a period of time. A particular user may utilize one or more endpoints (e.g., computer, telephone, cell phone, etc.) at the same time whereby one or more of such endpoints may report and/or present presence information.

In another embodiment, presence server 112 manages presence information, such as for presentation by and/or receiving presence inputs from, first endpoint 106, second endpoint 108, and/or other in endpoints utilizing network 110. Associating server 114 provides one source of associations between second user 104 and/or first user 102. Associating server 114 may provide one or more other services to first user 102 and/or second user 104, such as email, telephony, video, and/or text as well as other services such as may be provided in a particular business environment, such as management, document processing, scheduling, artistic and creative, science and engineering, accounting and financial, human resources, and/or other business or project services. In a further embodiment, associating server 114 may be physically and/or logically local to a particular enterprise, off-site (e.g., cloud, software as a service, etc.), or a combination thereof.

Network 110 may be entirely within the confines of a particular physical structure, such as one building or a portion of the building, or span multiple physical locations. Network 110 may comprise portions of public networks (e.g., Internet), private networks (e.g., PBX, WAN, LAN, WLAN, etc.) and/or other communications networks operable to convey presence data gathered from one endpoint (e.g., second endpoint 108) and provide the presence data to another endpoint (e.g., first endpoint 106).

Network 110 may comprise two or more endpoints, such as endpoints 106, 108, with the endpoints being variously embodied. In one embodiment, one or both of first endpoint 106 and/or second endpoint 108 may be or comprise a digital telephone, a computer, portable device (e.g., cell phone, smart phone, laptop, personal data assistant, tablet, smart watch, etc.), or other device operable to facilitate communication and/or the exchange of presence data between at least first user 102 and second user 104 via network 110.

Presence server 112 and associating server 114 may be distinct physical and/or logical devices. In another embodiment presence server 112 and associating server 114 are a single physical and/or logical device. Presence server 112 and associating server 114 may communicate directly or via network 110. Presence server 112 may also comprise or access an electronic data storage, such as to maintain user preferences for receiving and/or reporting presence information, default settings for an organization, a department, a group of individuals, and/or a specific individual. Presence server 112 may also maintain historical records of presence events, providing subscribing and unsubscribing services, and/or other management services.

In one embodiment, first user 102 is interacting with second user 104. Associating server 114 determines whether an association between first user 102 and second user 104 has been created. For example second user 104 may send first user 102 an email utilizing associating server 114 when configured as an email server. Accordingly presence server 112 is notified of the triggering event causing an association to be created between first user 102 and second user 104. Presence server 112 then subscribes first user 102 second user 104's presence, which may then be displayed on first endpoint 106. In another embodiment, the presence information for first user 102 is subscribed to by second user 104. The nature of the subscription may be determined by default settings provided by the users themselves and/or an enterprise, department, and/or other grouping of users providing default settings for users.

The automatic subscription request and the acceptance or blocking thereof is provided based upon an appropriate default setting and without human interaction. As is performed in the prior art systems, a user may issue a request to subscribe to presence information for another user, for example, to add a user to a “buddy list.” The subject of such a subscription request to be added to a “buddy list” may accept or decline, based upon default rules or be presented with the request to manually accept or decline. However, these prior art systems require human initiation, often a human response, and the presentation back to the initiator as to the acceptance or rejection.

In one embodiment, the request is automatically generated based upon another action unrelated to creating a subscription to the presence information, such as sending or receiving an email, and by automatically granting or denying the request: human interaction with the system is not required. If a request defaults to CONFIRM or BLOCK, the request and the response may be unknown to first user 102 and/or second user 104. For example, ACCEPT allows for the creation of a subscription; but, as CONFIRM requires human interaction, such a default policy may be considered as BLOCK for automatically generated subscription requests provided by certain embodiments herein.

In another embodiment, the subscription process may be for an additional subscription datum. For example, second user 104 may send subscribing user 102 an email. Associating server 114, such as when associating server 114 is an email server, may present the email as a triggering event to presence server 112. Presence server 112 may then attempt to create a subscription for the presence of one or both of first user 102 and second user 104 for the other. However, a certain presence datum, such as AVAILABLE/BUSY, may already be provided. Subscription information based upon the triggering event may add additional presence datum to the subscription, such as “in a meeting,” “out of the office,” “do not disturb,” etc.

In another embodiment, the subscription resulting from the triggering event is time-limited. The specific time may be determined as a matter of design choice. The duration of time may be a default value for all automatic subscriptions. However, in another embodiment, the specific triggering event determines the duration of the subscription. For example, second user 104 may send an email via server 114 to first user 102 and cause presence server 112 to create a subscription for one length of time, such as a week or two. However, if that same email was sent to every employee in a large organization including first user 102, then the relationship may be considered less personal and may result in a triggering event whereby presence server 112 creates the subscription for a shorter length of time, such as a few hours or a few days. As a further option, certain events may not be considered triggering events. A large organization receiving an email to all employees from the organization's CEO may be excluded as a triggering event. Other events, such as a scheduled meeting, may result in a subscription for a number of days or weeks following the meeting. As a further option, certain meetings may result in a subscription that is initiated upon a delay. For example, second user 104 may be a human resources officer who has little interaction with first user 102 except for an annual performance review of first user 102. First user 102 may schedule a meeting to discuss the annual review months in advance. However, presence information may be unwarranted until the scheduled meeting is a few days or weeks prior, such as to manage any developing scheduling conflicts, discuss any information that should be brought to the meeting, etc. Optionally, the presence information may be continued for a period of time, such as a few days or weeks following the meeting, such as to facilitate any follow-up discussions.

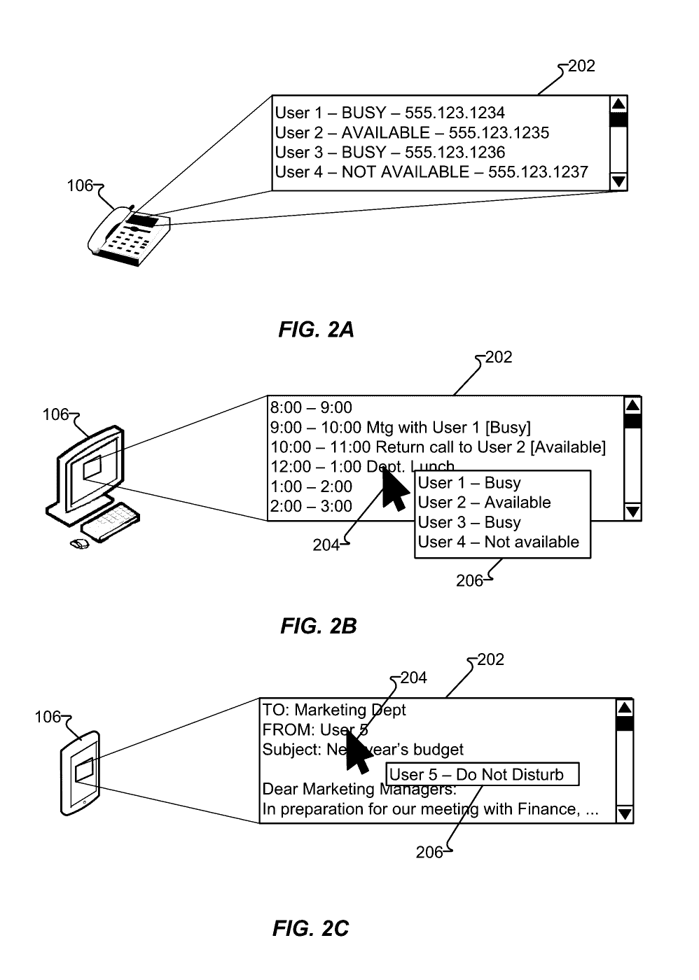

FIGS. 2A, 2B, and 2C depict an endpoint 106 in accordance with embodiments of the presence disclosure. In one embodiment, endpoint 106 is embodied as a telephone operable to receive presence data from presence server 112 for displaying presence indicia for subscribed users on display 202. Display 202 may be configured to display presence information for a number of other users up to all users within a given business entity, communications network (e.g., network 110), or other organization.

In one embodiment, presence information may be granted for any user on a system. However, in order to avoid unnecessary data traffic caused by presence information, presence information is not provided except when indicia thereof is operable to being observed, such as by display 202 of first endpoint 106 displaying certain users. First user 102's scrolling display 202 may cause presence server 112 to subscribe first user 102 to the subscription information for one or more other users as their indicia is made available on display 202. As a result, users whose presence is displayed on display 202 are subscribed for presentation by first endpoint 106. In another embodiment, the duration of the subscription may be limited to a particular user's indicia no longer being presented on display 202, such as being beyond a certain level of display (e.g., five pages below the current page of user indicia, ten pages above the current page of user indicia, etc.), or the occurrence of another event, such as first user 102 performing an operation (e.g., placing a call, closing the user directory, etc.) on first endpoint 106 indicating no additional user presence information is desired.

FIG. 2B depicts endpoint 106 as a desktop computer. In one embodiment, display 202 is associated with a calendar or schedule application being presented on a display associated with endpoint 106. In one embodiment, display 202 displays a schedule for a user and for events involving other users, indicia of their presence. The indicia may be textual, graphical (e.g., color and/or shapes of graphical elements to indicate availability or non-availability, etc.), or other indicator providing indicia of the associated subscribed user's availability. In one embodiment, pointer 204 is placed over as a “hover” or clicked to select the group causing pop-up window 206 to be presented to provide indicia of the individual members of the group. As a further option, availability of the entire group may be provided, such as in a manner similar to an indicia of availability for one user.

FIG. 2C depicts endpoint 106 as a portable device (e.g., smart phone, tablet, etc.). In one embodiment, display 202 comprises an email. The user may utilize a finger or other pointing device, indicated as pointer 204, to “hover” or clicked to select the group causing pop-up window 206 to be presented to provide indicia of the individual members of the group. As a further option, availability of the entire group may be provided, such as in a manner similar to an indicia of availability for one user.

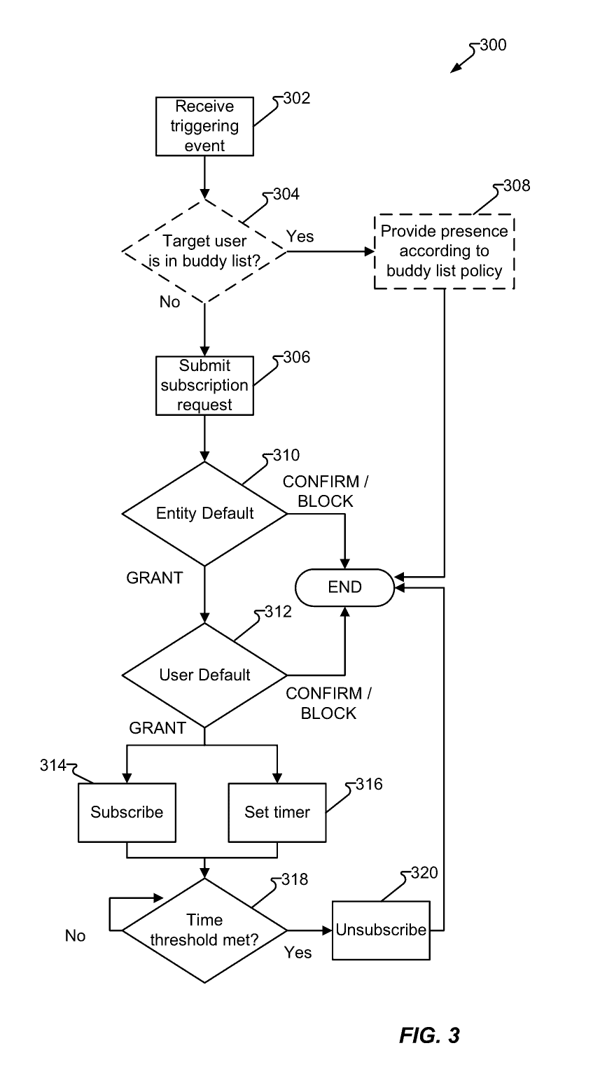

FIG. 3 depicts process 300 in accordance with embodiments of the presence disclosure. In one embodiment, process 300 begins at step 302 receiving a triggering event, such as presence server 112 receiving a triggering event from associating server 114, and indicating an association between two or more users of the communication system, such as first user 102 and second user 104. Optionally step 304 determines if a target user is already on a buddy list for particular user. For example, first user 102 may have a previous subscription to the presence information for second user 104. As a further option, if step 304 is determined in the affirmative, processing may be continued at step 308 whereby presence information is provided according to a buddy list policy.

In another embodiment, step 304 may provide additional information, such as a particular presence datum not provided under step 308, such as “do not disturb” as opposed to “unavailable,” in which case processing may continue to step 306 to add the additional presence datum to the subscription. Step 306 causes a subscription request to be issued on behalf of the subscribing user to receive presence information for the subscribed user, such as first user 102 requesting presence information for second user 104. However, it should be noted that step 306 is an automated process done on behalf of first user 102. Next, step 310 determines if there is an entity default. The entity may be a business organization, a default based on position (e.g., executives, those with access to sensitive data, etc.), department, and/or other grouping of individuals. If step 310 determines the entity default is to ACCEPT request for subscription information, processing may continue to user default step 312 whereby the particular individual, whose presence information is desired, may then have the appropriate default rule applied. If step 310 and/or step 312 have a default to CONFIRM or BLOCK, such subscription request process 300 may end. Optionally, the user may have an explicit request to the user to add the user to a buddy list. However, if steps 310 and 312 have ACCEPT as a default position, processing may continue to steps 314 and optionally step 316.

Steps 314 and 316 are shown as discrete process steps executed in parallel. However, in other embodiments, steps 314 and 316 may be executed serially or as one combined step. Step 314 subscribes the user to the presence information for the other user. Step 316 starts a timer, sets a timestamp, or other appropriate indicator of start time, duration, and/or end time so that the subscription initiated in step 314 may terminate at the appropriate time. Step 318 then determines if the threshold time has been met and, if yes, step 320 unsubscribes the user from the presence information and, if no, step 318 may loop until determined in the affirmative.

Upon step 320 executing, the subscription or additional subscription datum that was subscribed in step 314 is unsubscribed for the user. Optionally, some subscription data may be maintained, such as by defaulting to a corporate or other default policy and/or a buddy list policy provided in optional step 308. During the time between step 314 and step 320 executing, the presence information subscribed to is active and the presence information of the subscribed user (e.g., second user 104) is made available to a subscribing user (e.g., presenting subscription information to first user 102 on first endpoint 106).

In another embodiment, process 300 may encounter another event 302 prior to the execution of step 320 and after step 314. In such an embodiment, step 316 may be re-executed to reset the time or otherwise extend the time. In another embodiment, if the subsequent event 302 has a shorter duration than a prior event 302, the shorter duration event may be ignored or added to the total subscription time as a matter of design choice. In a further embodiment, two events 302 may have an associated time set in step 316 and may be combined by simple addition or other factor as a matter of design choice. For example, a subscription lasting one week followed by a second event also associated with a subscription lasting one week may, when combined, result in a subscription of three weeks.

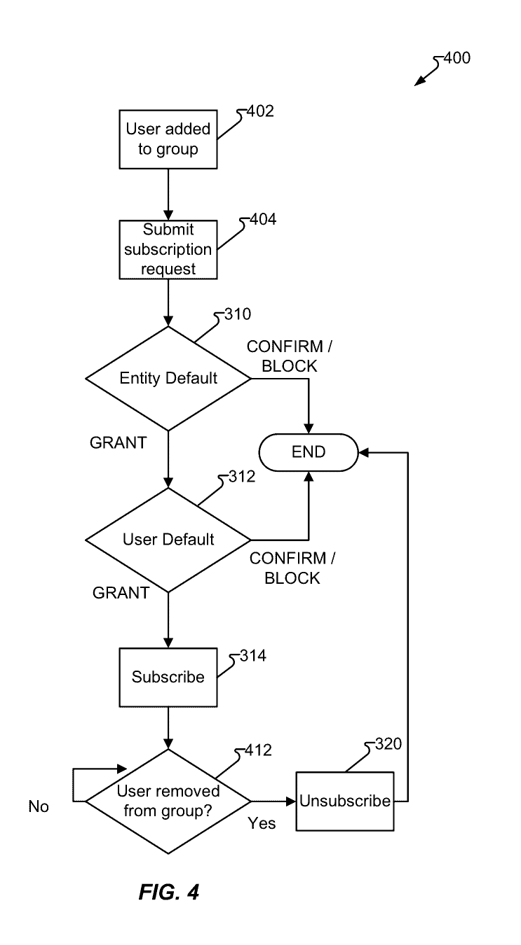

FIG. 4 depicts process 400 in accordance with embodiments of the presence disclosure. The trigger event is variously embodied. First user 102 subscribes to the presence information for second user 104 based on a need and, optionally, unsubscribe from the presence information upon termination of the need. In one embodiment, a need occurs when a user, such as second user 104, is added to a group for which another user, such as first user 102, subscribes to presence information for the members of the group. In other embodiments, the group may be a project, task, list of email recipients and/or senders, user's having a geospatial relationship (e.g., all employees on the 21^{st} floor, etc.), or other need-based relationship.

In one embodiment, process 400 executes step 402 wherein a user is added to a group. Next, block 404 submits a subscription request on behalf of at least one other member of the group or other interested party of the group. As described with respect to FIG. 3, step 310 and/or step 312 may determine if user and/or entity rules are CONFIRM or BLOCK in which case process 400 may end, otherwise, processing continues to step 314 and the user is subscribed. In another embodiment, the subscription provided in step 314 may be permanent.

In another embodiment, step 412 determines if the subscribed user has been removed from the group. If no, step 412 may be reconsidered at a later time or upon an event, such as an indication that the user is no longer a member of the group. If step 412 is answered in the affirmative, step 320 then unsubscribes from the user's presence information that was subscribed in step 314.

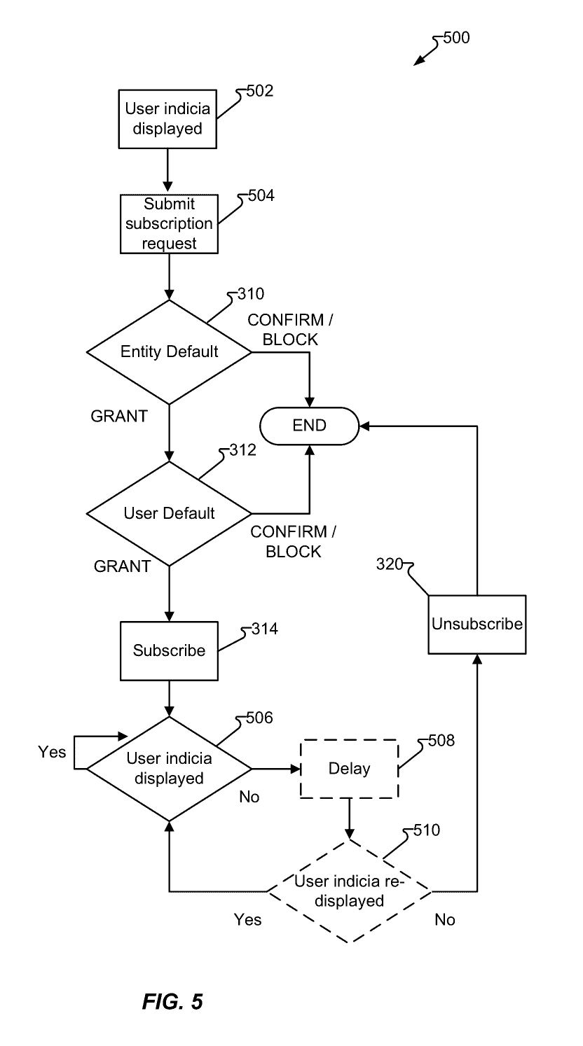

FIG. 5 depicts process 500 in accordance with embodiments of the presence disclosure. The trigger event is variously embodied. In one embodiment, step 502 determines a user's indicia is displayed, such as on a telephone endpoint displaying indicia (e.g., user name, real name, department, role, etc.) on a scrollable window of the endpoint (see, FIG. 2, display 202). While the user's indicia is displayed, presence information may be desirable. Step 504 submits the subscription request. As described with respect to FIG. 3, step 310 and/or step 312 may determine if user and/or entity rules are CONFIRM or BLOCK in which case process 400 may end, otherwise, processing continues to step 314 and the user is subscribed. In another embodiment, the subscription provided in step 314 may be permanent.

In another embodiment, step 506 may determine if the user's indicia is still displayed. If determined in the affirmative, process 500 may be suspended or loop back to step 506. If step 506 is determined in the negative, process 500 may proceed to optional steps 508, 510 and directly to step 320 to unsubscribe. In another embodiment, step 508 is executed to provide a delay, such as to prevent unnecessary subscribing/unsubscribing when a user is performing actions quickly (e.g., scrolling up and down a list of indicia on display 202). Step 510 may optionally be executed to determine if the indicia for the user has been re-displayed. Such as when a user has returned to the user. If no, step 320 may be executed to unsubscribe the user. IF yes, step 506 may be re-executed to determine continue the process and otherwise delay the execution of step 320.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a presence server;
an input interface of the presence server configured to receive a triggering event from a triggering device;
wherein the triggering device notifies the presence server, via the input interface, of a triggering event associating the first user with the second user;
wherein the presence server, in response to the triggering event, automatically and without human intervention, subscribes the first user to presence data for the second user; and
an output interface of the presence server configured to provide presence information of the second user to a first endpoint associated with the first user while the first user is subscribed to the presence data of the second user.

2. The system of claim 1, wherein the presence server unsubscribe the first user to the presence data of the second user upon receiving, via the input interface, a termination event negating the triggering event.

3. The system of claim 1, wherein the first endpoint comprises the triggering device.

4. The system of claim 1, wherein the subscription is a time limited subscription determined by an event type of the triggering event.

5. The system of claim 3, wherein the presence server is further configured to unsubscribe the first user to the presence of the second user upon expiration of the time limited subscription.

6. The system of claim 3, wherein the presence server is further configured to extend the time limited subscription upon the first user having a previously existing time limited subscription to the presence of the second user.

7. The system of claim 1, wherein the presence server is configured to subscribe the first user to the presence of the second user, comprising a first set of presence data, and in response to the triggering event, the presence server is further configured to subscribe the first user to at least one additional subscription event not enabled by the first set of presence data.

8. The system of claim 7, wherein the presence server is further configured to automatically unsubscribe the first user from the at least one additional subscription event not enabled by the first set of presence data, after the predetermined duration of time after the subscription.

9. The system of claim 1, wherein the presence server is further configured to subscribe the first user to the presence of the second user upon determining the first user does not have a previously existing subscription to the second user.

10. The system of claim 1, wherein the presence server is further configured to, upon receiving the triggering event via the input interface, subscribe the second user to the presence of the first user and wherein the output interface is further configured to provide presence information of the first user to the second endpoint while the second user is subscribed to the presence data of the first user.

11. A method, comprising:
receiving a triggering event from a triggering device indicating an association between a first user and a second user;
in response to the triggering event, automatically and without human intervention, subscribing the first user to presence data for the second user;
receiving presence data of the second user from a second endpoint associated with the second user; and
determining the first user is presently subscribed to the presence data of the second user, and in response to the determining, outputting the presence data of the second user to a first endpoint associated with the first user.

12. The method of claim 11, wherein the presence data for the second user is determined by a presences datum reported by the second endpoint.

13. The method of claim 11, wherein subscribing further comprises subscribing the first user to a time limited subscription.

14. The method of claim 13, wherein the time limited subscription has a duration determined by an event type of the triggering event.

15. The method of claim 11, wherein subscribing comprises maintaining a previously existing subscription to the second user.

16. The system of claim 15, wherein the previously existing subscription to the second user comprises blocking the first endpoint from receiving presences information of the second user.

17. A non-transitory computer-readable medium that when read by a computer causes the computer to perform:
receiving a triggering event from a triggering device indicating an association between a first user and a second user;
in response to the triggering event, automatically and without human intervention, subscribing the first user to presence data for the second user;
receiving presence data of the second user from a second endpoint associated with the second user; and
determining the first user is presently subscribed to the presence data of the second user, and in response to the determining, outputting the presence data of the second user to a first endpoint associated with the first user.

18. The non-transitory computer-readable medium of claim 17, wherein the instructions for subscribing further comprise instructions for subscribing the first user to a time limited subscription.

19. The non-transitory computer-readable medium of claim 18, wherein the time limited subscription has a duration determined by an event type of the triggering event.

20. The non-transitory computer-readable medium of claim 11, wherein the instructions further comprise instructions to subscribe the second user to the presence of the first user in response to the triggering event.
